(19) United States
(12) Patent Application Publication
(10) Pub. No.: US 2006/0235610 A1
(43) Pub. Date: Oct. 19, 2006

(54) Map-based trajectory generation

(75) Inventors: Kartik B. Ariyur, Minnetonka, MN (US); Dharmashankar Subramanian, New Hope, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/105,788

(22) Filed: Apr. 14, 2005

(51) Int. Cl. G01C 21/00; G01C 21/26

(52) U.S. Cl. 701/202; 701/200

(57) ABSTRACT

A mobile vehicle navigation system includes a polygon rasterization module configured to perform a polygon rasterization process on one or more maps of an obstacle field to identify obstacle-free regions within the obstacle field. The navigation system further includes a shortest path module configured to select an optimal trajectory along which the mobile vehicle can safely traverse the obstacle field and a control module configured to ensure that the mobile vehicle can successfully traverse the optimal trajectory selected by the shortest path module. The navigation system can advantageously generate obstacle-free trajectories through an obstacle field in substantially real time in response to user requests.

### TECHNICAL FIELD

This application relates in general to unmanned mobile vehicles and, more specifically, to map-based systems and methods for generating trajectories for such vehicles.

### BACKGROUND

Unmanned mobile vehicles, such as, for example, unmanned aerial vehicles (UAVs) or unmanned ground vehicles, are becoming more commonly used in a wide variety of applications. These vehicles are typically equipped with one or more sensors to monitor and collect data regarding the vehicle's surrounding environment. This data is often transmitted over one or more wireless data links to a human operator or a central data gathering station.

Unmanned mobile vehicles are also typically equipped with navigation systems to enable the vehicles to travel to their intended destinations. These navigation systems often generate optimal trajectories based on maps of the locations in which the vehicles are traveling. If a vehicle is traveling through an environment having obstacles such as buildings or trees, then the navigation system typically needs time to plot a safe course for the vehicle through the obstacle field. For example, standard approaches implemented by some map-based navigation systems for generating obstacle-free trajectories are approximations to variational problems. These problems typically take on the order of several seconds to a few minutes to solve for, even in the case of simple obstacle fields.

In some applications, however, unmanned mobile vehicles are used in environments in which faster response times by navigation systems are desired. For example, unmanned mobile vehicles may be used by military or law enforcement personnel in urban aerial combat or surveillance operations. In these applications, it is desirable that the vehicles respond very rapidly to user requests made in response to rapidly-changing conditions on the ground. In order to accomplish this goal, the vehicles' navigation systems must be able to generate obstacle-free trajectories in substantially real time rather than over a period of several minutes or even seconds.

Accordingly, there is a need for map-based navigation systems that can generate obstacle-free trajectories and navigate through complex terrain in substantially real time.

### SUMMARY OF THE INVENTION

The above-mentioned drawbacks associated with existing map-based navigation systems are addressed by embodiments of the present invention and will be understood by reading and studying the following specification.

In one embodiment, a mobile vehicle navigation system comprises a polygon rasterization module configured to perform a polygon rasterization process on one or more maps of an obstacle field to identify obstacle-free regions within the obstacle field. The navigation system further comprises a shortest path module configured to select an optimal trajectory along which the mobile vehicle can safely traverse the obstacle field, and a control module configured to ensure that the mobile vehicle can successfully traverse the optimal trajectory selected by the shortest path module.

In another embodiment, a method of generating an obstacle-free trajectory for a mobile vehicle through an obstacle field comprises performing a polygon rasterization process to identify obstacle-free regions within the obstacle field. The method further comprises determining a number of obstacle-free trajectories through the obstacle field, selecting an optimal obstacle-free trajectory through the obstacle field, and solving a control problem to ensure that the mobile vehicle can successfully traverse the selected trajectory.

In another embodiment, a method of generating an obstacle-free trajectory for a mobile vehicle through an obstacle field comprises performing precomputations regarding obstacle-free regions within the obstacle field and regarding the safety envelope of the mobile vehicle before the mobile vehicle is in transit. The method further comprises receiving a user request to change the destination of the mobile vehicle while the mobile vehicle is in transit, and generating an obstacle-free trajectory along which the mobile vehicle can safely reach the changed destination in substantially real time in response to the user request.

The details of one or more embodiments of the claimed invention are set forth in the accompanying drawings and the description below. Other features and advantages will become apparent from the description, the drawings, and the claims.

### BRIEF DESCRIPTION OF THE DRAWINGS

FIG. 1 is a schematic of a mobile vehicle traveling toward a destination.

FIG. 2 is a schematic of the mobile vehicle illustrated in FIG. 1 after its destination is changed in response to a user request.

FIG. 3 is a Voronoi diagram of an obstacle field.

FIGS. 4A-4H are a series of graphs illustrating the change in velocity of the mobile vehicle along graph edges of the vehicle's trajectory in various cases of a one-dimensional control problem.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

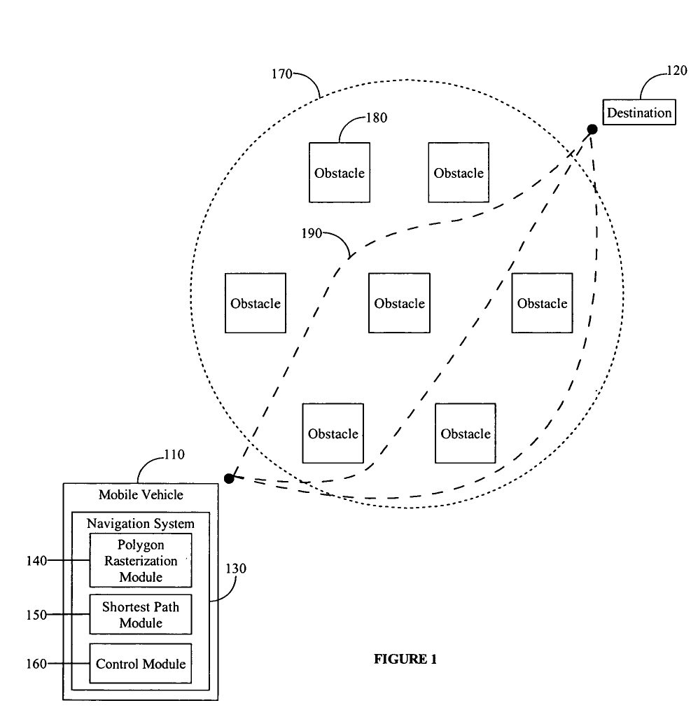

FIG. 1 is a schematic of a mobile vehicle 110 traveling toward a destination 120. In a preferred embodiment, the mobile vehicle 110 comprises a hover-capable UAV, such as, for example, an organic air vehicle (OAV). In other embodiments, however, the mobile vehicle 110 may comprise any of a wide variety of other unmanned mobile vehicles, such as, for example, fixed-wing UAVs, mobile ground vehicles, unmanned underwater vehicles (UUVs), or the like. In the illustrated embodiment, the mobile vehicle 110 comprises a navigation system 130 including a polygon rasterization module 140, a shortest path module 150, and a control module 160. Those of ordinary skill in the art will understand that the mobile vehicle 110 and the navigation system 130 comprise numerous additional components, such as, for example, sensors, processors, communication devices, etc. which, for simplicity, are not shown in the illustrated embodiment.

The destination 120 may be the final destination of the mobile vehicle 110, or it may be an intermediate destination along the vehicle's route, such as a waypoint generated by the vehicle's navigation system 130. In the embodiment illustrated in FIG. 1, an obstacle field 170 is located between the mobile vehicle 110 and its destination 120. The obstacle field 170 includes a number of obstacles 180, such as buildings, trees, or mountains, which are known to the vehicle's navigation system 130. In some cases, obstacles 180 may be known to the navigation system 130 because they are included on maps made available to the navigation system 130 in advance. In other cases, obstacles 180 may be detected by one or more of the vehicle's sensors and made known to the navigation system 130 while the mobile vehicle 110 is in transit.

In operation, the navigation system 130 identifies a number of possible paths 190 over which the mobile vehicle 110 can travel safely through the obstacle field 170 to reach its destination 120 without encountering any obstacles 180. Once these possible paths 190 have been identified, the navigation system 130 then determines an optimal trajectory for the mobile vehicle 110. In conventional systems, this process typically involves approximations to variational problems, which can take on the order of several seconds or even minutes to solve for. In the illustrated embodiment, however, this process can advantageously be performed in less than a second, as described in more detail below.

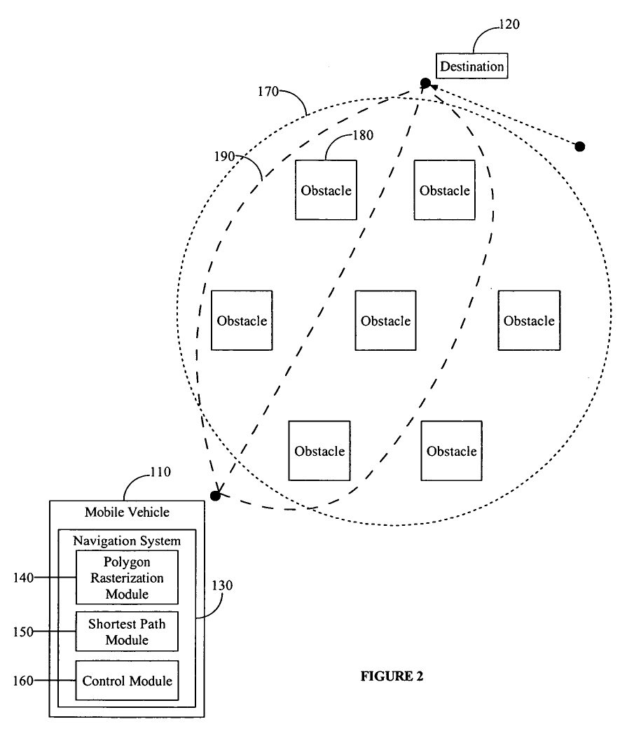

In some applications, the destination 120 of the mobile vehicle 110 may change while the vehicle is in transit, as illustrated in FIG. 2. Such a change may occur for a number of reasons. For example, the mobile vehicle 110 may be used by military or law enforcement personnel in urban aerial combat or surveillance operations, and the destination 120 may change due to a user request made in response to changing conditions observed on the ground. When such a change occurs, a delay of several minutes or even seconds on the part of the navigation system 130 (to identify new possible paths 190 to the changed destination 120 and determine an optimal trajectory) is undesirable.

Embodiments of the present invention enable the navigation system 130 to generate optimal trajectories in response to user requests more rapidly by performing a number of precomputation steps before the mobile vehicle 110 is in transit. For example, the polygon rasterization module 140 can perform a precomputation of obstacle-free regions within the obstacle field 170. In some embodiments, this step is carried out by performing a polygon rasterization process on the maps made available to the navigation system 130 before the mobile vehicle 110 is in transit.

Polygon rasterization is a process that is well-known and well-understood by those of skill in the art, which has been extensively developed and utilized in a wide variety of applications, particularly in the areas of computer gaming, animation, and virtual reality. In general, polygon rasterization involves converting vector-based graphs, such as the maps utilized by the navigation system 130, into raster-based representations of the same information. By performing this conversion process, the polygon rasterization module 140 can readily identify obstacle-free regions within the obstacle field 170 in advance, such that obstacle-free paths through the obstacle field 170 can be generated in substantially real time while the mobile vehicle 110 is in transit.

Using currently-available processors and techniques, the polygon rasterization module 140 can typically identify obstacle-free regions within an obstacle field 170 having an area of about one square kilometer on the order of seconds. The polygon rasterization module 140 can identify obstacle-free regions at different elevations, if desired, and the regions can be represented as a series of three-dimensional graphs. This process can usually be performed well before the mobile vehicle 110 is in transit, because the appropriate maps are typically made available to the navigation system 130 well in advance. For example, in many urban aerial combat or surveillance operations, the relevant maps are available several hours before the operations commence.

Once the obstacle-free regions have been identified by the polygon rasterization module 140, the navigation system 130 can determine safe paths 190 through the obstacle field 170. The paths 190 are represented by traversable graphs through the obstacle field 170 (at different elevations, in some embodiments), on which every edge of a graph is obstacle-free.

For example, in some embodiments, the obstacle field 170 can be represented using a trapezoidal map, as described in Chapter 13 of the following book: Computational Geometry by M. de Berg, M. van Kreveld, M. Overmars, O. Schwarzkopf, Springer, Berlin 1998. This chapter is incorporated herein by this reference. In other embodiments, the obstacle field 170 can be represented using a Voronoi diagram, as described in Chapters 3 and 4 of the following book: Spatial Tesselations: Concepts and Applications of Voronoi Diagrams, Atsuyuki Okabe, Barry Boots, Kokichi Sugihara, Sung Nok Chiu. These chapters are incorporated herein by this reference. The distances from the graph edges to the obstacles can be obtained directly from the algorithm used to find the graph edges (e.g., the trapezoidal map or the Voronoi diagram).

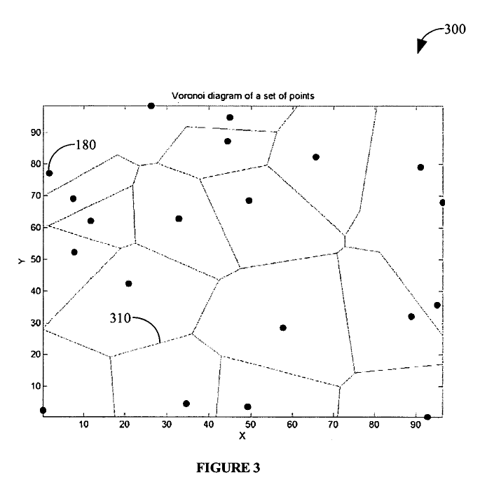

One example of a Voronoi diagram 300 is illustrated in FIG. 3. In general, a Voronoi diagram of a set of points S={p₁, . . . , pₙ} in a space (Rⁿ) decomposes the space into regions, Rᵢ, around each geometric primitive (e.g., points, lines, polygons, surfaces, polyhedrons, solids, etc.), pᵢ, such that all the points in the region Rᵢ are closer to pᵢ than to any other primitive. The Voronoi diagram 300 illustrated in FIG. 3 shows a set of 20 points obtained as ordered pairs from a uniform distribution over the interval [0 100].

If the sites of S are the centers of the obstacles 180, the edges 310 of the Voronoi diagram 300 define the possible channels through the obstacle field 170 that maximize the distance to the obstacles 180. Therefore, in planning possible paths for the mobile vehicle 110 through the obstacle field 170, it is often “safest” to traverse the edges 310 of the Voronoi diagram 300.

In some embodiments, the use of Voronoi diagrams 300 advantageously speeds up the computation of safe paths through the obstacle field 170. Moreover, the use of Voronoi diagrams 300 can facilitate the acceleration of this computation using computer graphics hardware, as described above. Another advantage of using Voronoi diagrams 300 is that numerical errors in the computation of safe paths have been quantified for distance error, as reported in the following publications: (a) Interactive motion planning using hardware-accelerated computation of generalized Voronoi diagrams by Hoff, Kenneth III; Culver, Tim; Keyser, John; Lin, Ming C.; Manocha, Dinesh; Source: Proceedings—IEEE International Conference on Robotics and Automation, v 3, 2000, p 2931-2937; (b) Fast computation of generalized Voronoi diagrams using graphics hardware by Hoff, Kenneth E. III; Culver, Tim; Keyser, John; Lin, Ming; Manocha, Dinesh; Source: Proceedings of the ACM SIGGRAPH Conference on Computer Graphics, 1999, p 277-286; (c) Fast and simple 2D geometric proximity queries using graphics hardware by Hoff III, K. E.; Zaferakis, A.; Lin, M.; Manocha, D.; Source: Proceedings of the Symposium on Interactive 3D Graphics, 2001, p 145-148. These publications, in their entireties, are incorporated herein by this reference.

If detailed and accurate map information is available, the use of Voronoi diagrams 300 advantageously simplifies the path planning problem to one of graph search. Even without such map information, research has been done to combine the path planning problem with potential methods, since distance to obstacles 180 for possible use in a potential function is available from the computation.

On the other hand, the use of Voronoi diagrams 300 can also present drawbacks. For example, map offsets that may occur due to a GPS bias, for example, can shift the Voronoi diagram 300 used to represent a given obstacle field 170. In addition, the Voronoi diagram 300 can change significantly if there is a measurement error in the location of an obstacle 180, such as a “combinatorial error” due to insufficient or inaccurate spatial sampling. Such errors depend upon the spatial resolution of the sensors, as well as the spatial discretization used in the computation. Unfortunately, there are no bounds on such combinatorial errors; a discrete Voronoi vertex may be arbitrarily far from its continuous counterpart. Therefore, such errors can lead to paths that, if followed, would result in a collision between the mobile vehicle 110 and an obstacle 180.

As described above, the navigation system 130 identifies safe paths 190 through the obstacle field 170, which are typically represented by traversable graphs through the obstacle field 170, on which every edge of a graph is obstacle-free. The shortest path module 150 can then perform a precomputation of all-pairs shortest paths between nodes of the graph to determine an optimal trajectory for the mobile vehicle 110. Even in the worst case scenario, this is a problem of only cubic complexity with the number of nodes of the graph. Using currently-available processors and techniques, this optimization problem can be solved in less than one second, as opposed to several seconds or minutes, as required by conventional systems. Therefore, an optimal, obstacle-free trajectory can be identified and selected in substantially real time (i.e., less than a second) if the destination 120 of the mobile vehicle 110 changes while the vehicle is in transit.

The precomputation performed by the shortest path module 150 can be carried out using a number of well-known algorithms, such as, for example, Dijkstra's algorithm for shortest path on a graph, as described on page 595 of the following book: Introduction to Algorithms, second ed, by T. H. Cormen, C. E. Leiserson, R. L. Rivest, C. Stein, MIT Press, 2003. The description of Dijkstra's algorithm in this book is incorporated herein by this reference.

In some embodiments, once an optimal, obstacle-free trajectory has been selected, the control module 160 solves a one-dimensional control problem to ensure that the mobile vehicle 110 can successfully traverse the selected trajectory. This control problem takes into account a number of factors, such as the maneuverability limitations of the mobile vehicle 110, as well as its safety envelope.

For example, the control module 160 ensures that the mobile vehicle 110 will not be commanded to perform a sharp turn while it is traveling at a speed that makes such a turn impossible to perform. In addition, the control module 160 ensures that an adequate safety envelope, or buffer region, will exist around the mobile vehicle 110 at all times as it traverses the obstacle field 170. This safety envelope around the mobile vehicle 110, which is necessary due to inherent limitations and inaccuracies in the vehicle's sensors and control mechanisms, is a function of several factors, such as the speed and acceleration of the mobile vehicle 110, as well as its applicable input and state constraints. Because many of these factors are known in advance by the vehicle's navigation system 130, the control module 160 can estimate worst-case deviations from the vehicle's commanded trajectory and thereby make an a priori determination of the vehicle's safety envelope. In some embodiments, the graph edges generated by the polygon rasterization module 140 can be filtered, or pruned, using the vehicle's navigation envelope. For example, if traversing a graph edge would result in a vehicle's navigation envelope intersecting one or more obstacles 180, the edge can be dropped.

A detailed description of the one-dimensional control problem in one exemplary embodiment of the control module 160 is provided below. In this embodiment, the objective of the one-dimensional control problem is to determine the maximum possible velocity of the mobile vehicle 110 along each graph edge of the vehicle's trajectory. In this embodiment, V₁ is the initial velocity of the mobile vehicle 110 for a given graph edge, V₂ the final velocity of the mobile vehicle 110 for the same graph edge (determined by the sharpness of the following turn, the vehicle's maneuvering capabilities, etc.), V_{Max} is the maximum velocity of the mobile vehicle 110, a_{Max}⁺ is the maximum positive acceleration of the mobile vehicle 110, a_{Max}⁻ is the maximum negative acceleration of the mobile vehicle 110, and S_{Total} is the total distance of the graph edge. The following three cases are possible: (1) V₂<V₁; (2) V₂=V₁; and (3) V₂>V₁. Each of these cases is discussed in turn below.

Case 1: V₂<V₁

The following relationships can be established:

$$\begin{matrix}{t}_{1} = \frac{{V}_{Max} - {V}_{1}}{{a}_{Max}^{+}} ; S = {V}_{1} {t}_{1} + \frac{1}{2} {a}_{Max}^{+} {t}_{1}^{2} & ( 1 ) \\ {t}_{2} = \frac{{V}_{Max} - {V}_{2}}{{a}_{Max}^{-}} ; {S}_{2} = {V}_{Max} {t}_{2} + \frac{1}{2} {a}_{Max}^{-} {t}_{2}^{2} & ( 2 )\end{matrix}$$

Subcase 1(A):

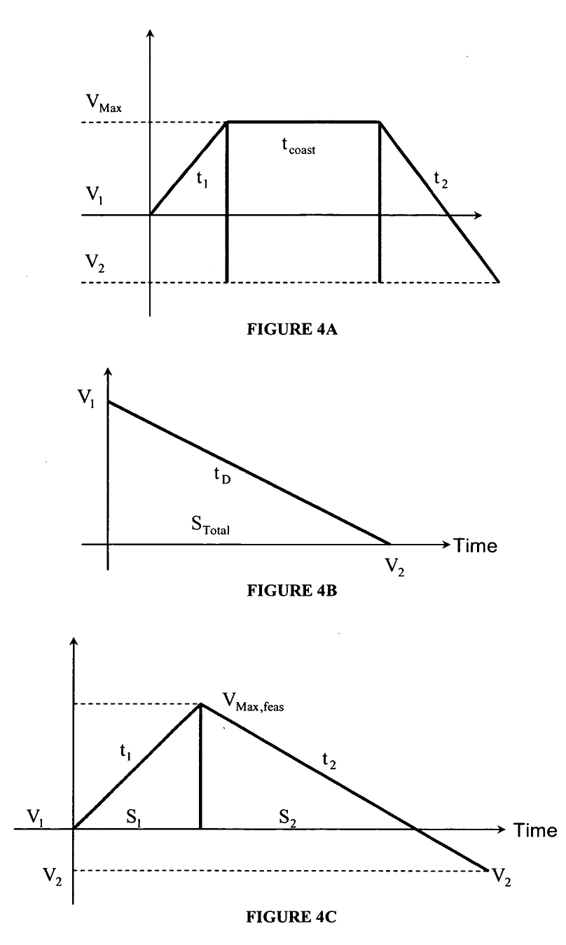

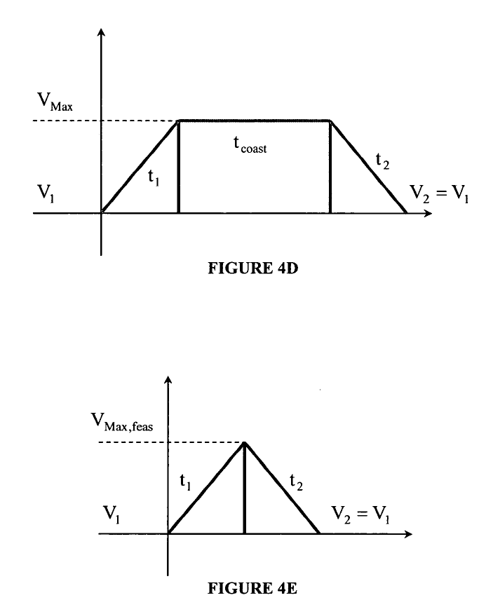

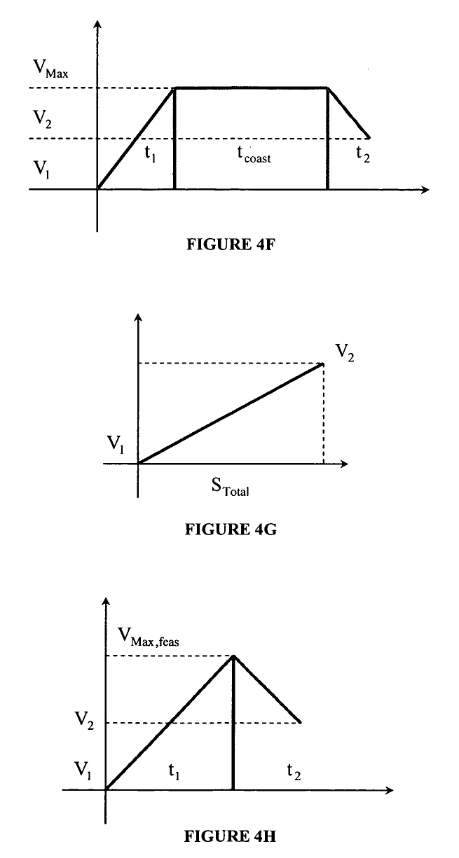

If (S₁<S_{Total}) and (S₁+S₂≦S_{Total}) then the change in velocity of the mobile vehicle 110 follows the pattern illustrated in the graph of FIG. 4A. Based on this pattern, the time spent accelerating by the mobile vehicle 110 to reach V_{Max} can be determined using Equation 1 above, the time spent decelerating to reach V₂ can be determined using Equation 2 above, and the time spent “coasting” at V_{Max} can be determined using the following equation:

$${t}_{coast} = \frac{- ( {S}_{1} + {S}_{2} ) + {S}_{Total}}{{V}_{Max}} \qquad ( 3 )$$

Subcase 1(B):

$$\begin{matrix}Let {t}_{D} = \frac{{V}_{1} - {V}_{2}}{{a}_{Max}^{-}} & ( 4 ) \\ {S}_{D} = {V}_{1} {t}_{D} - \frac{1}{2} {a}_{Max}^{-} {t}_{D}^{2} & ( 5 )\end{matrix}$$

If S_{D}=S_{Total}, then the mobile vehicle 110 has no time to accelerate. In this scenario, the mobile vehicle simply decelerates to V₂, as illustrated in the graph of FIG. 4B.

Subcase 1(C):

If S_{D}<S_{Total}, then the mobile vehicle 110 has time to accelerate but does not have time to reach its maximum velocity, V_{Max}, before it begins decelerating to reach V₂. In this scenario, the change in velocity of the mobile vehicle 110 follows the pattern illustrated in the graph of FIG. 4C. The maximum velocity reached by the mobile vehicle 110 is V_{Max,feas}; the times spent accelerating and decelerating can be determined using the following equations:

$$\begin{matrix}\begin{matrix}Quadratic \\ in\end{matrix} \\ {V}_{Max , feas}\end{matrix} \{ \begin{matrix}{V}_{Max , feas} = {V}_{1} + {a}_{Max}^{+} {t}_{1} \\ or t = \frac{( {V}_{Max , feas} - {V}_{1} )}{{a}_{Max}^{+}} ; {S}_{1} = {V}_{1} {t}_{1} + \frac{1}{2} {a}_{Max}^{+} {t}_{1}^{2} \\ {S}_{Total} - {S}_{1} = {V}_{Max , feas} {t}_{2} - \frac{1}{2} {a}_{Max}^{-} {t}_{2}^{2} \\ where {t}_{2} = \frac{{V}_{Max , feas} - {V}_{2}}{{a}_{Max}^{-}}\end{matrix} Solving the quadratic \qquad ( 6 )$$

Case 2: V₂=V₁

The following relationships can be established:

$$\begin{matrix}{t}_{1} = \frac{{V}_{Max} - {V}_{1}}{{a}_{Max}^{+}} ; {S}_{1} = {V}_{1} {t}_{1} + \frac{1}{2} {a}_{Max}^{+} {t}_{1}^{2} & ( 7 ) \\ {t}_{2} = \frac{{V}_{Max} - {V}_{2}}{{a}_{Max}^{-}} ; {S}_{2} = {V}_{Max} {t}_{2} - \frac{1}{2} {a}_{Max}^{-} {t}_{2}^{2} & ( 8 )\end{matrix}$$

Subcase 2(A):

If (S₁<S_{Total}) and (S₁+S₂≦S_{Total}) then the change in velocity of the mobile vehicle 110 follows the pattern illustrated in the graph of FIG. 4D. In this scenario, the time spent accelerating by the mobile vehicle 110 to reach V_{Max} can be determined using Equation 7 above, the time spent decelerating to reach V₂ can be determined using Equation 8 above, and the time spent “coasting” at V_{Max} can be determined using the following equation:

$${t}_{coast} = \frac{- ( {S}_{1} + {S}_{2} ) + {S}_{T}}{{V}_{Max}} \qquad ( 9 )$$

Subcase 2(B):

If (S₁≧S_{Total}) or (S₁+S₂>S_{Total}), then the mobile vehicle 110 has time to accelerate but does not have time to reach its maximum velocity, V_{Max}, before it begins decelerating to reach V₂. In this scenario, the change in velocity of the mobile vehicle 110 follows the pattern illustrated in the graph of FIG. 4E. The maximum velocity reached by the mobile vehicle 110 is V_{Max,feas}; the times spent accelerating and decelerating can be determined using the following equations:

$$\begin{matrix}{V}_{Max , feas} = {V}_{1} + {a}_{Max}^{+} {t}_{1} & ( 10 ) \\ {S}_{1} = {V}_{1} {t}_{1} + \frac{1}{2} {a}_{Max}^{+} {t}_{1}^{2} & ( 11 ) \\ {S}_{T} - {S}_{1} = {V}_{Max , feas} {t}_{2} - \frac{1}{2} {a}_{Max}^{-} {t}_{2}^{2} & ( 12 ) \\ {t}_{2} = \frac{{V}_{Max , feas} - {V}_{2}}{{a}_{Max}^{-}} & ( 13 )\end{matrix}$$

The solution to Equations 10-13 is quadratic in V_{Max,feas}.

Case 3: V₂>V₁

The following relationships can be established:

$$\begin{matrix}{t}_{1} = \frac{{V}_{Max} - {V}_{1}}{{a}_{Max}^{+}} ; {S}_{1} = {V}_{1} {t}_{1} + \frac{1}{2} {a}_{Max}^{+} {t}_{1}^{2} & ( 14 ) \\ {t}_{2} = \frac{{V}_{Max} - {V}_{2}}{{a}_{Max}^{-}} ; {S}_{2} = {V}_{2} {t}_{2} - \frac{1}{2} {a}_{Max}^{-} {t}_{2}^{2} & ( 15 )\end{matrix}$$

Subcase 3(A):

If (S₁<S_{Total}) and (S₁+S₂≦S_{Total}), then the change in velocity of the mobile vehicle 110 follows the pattern illustrated in the graph of FIG. 4F. In this scenario, the time spent accelerating by the mobile vehicle 110 to reach V_{Max} can be determined using Equation 14 above, the time spent decelerating to reach V₂ can be determined using Equation 15 above, and the time spent “coasting” at V_{Max} can be determined using the following equation:

$${t}_{coast} = \frac{- ( {S}_{1} + {S}_{2} ) + {S}_{Total}}{{V}_{Max}} \qquad ( 16 )$$

Subcase 3(B):

$$\begin{matrix}Let {T}_{A} = \frac{{V}_{2} - {V}_{1}}{{a}_{Max}^{+}} & ( 17 ) \\ {S}_{A} = {V}_{1} {t}_{A} + \frac{1}{2} {a}_{Max}^{+} {t}_{A}^{2} & ( 18 )\end{matrix}$$

If S_{A}=S_{Total}, then the mobile vehicle 110 does not have time to accelerate to past V₂. In this scenario, the mobile vehicle simply accelerates to V₂, as illustrated in the graph of FIG. 4G.

Subcase 3(C):

If S_{A}<S_{Total}, then the mobile vehicle 110 has time to accelerate past V₂ but does not have time to reach its maximum velocity, V_{Max}. In this scenario, the change in velocity of the mobile vehicle 110 follows the pattern illustrated in the graph of FIG. 4H. The maximum velocity reached by the mobile vehicle 110 is V_{Max,feas}; the times spent accelerating and decelerating can be determined using the following equations:

$$Quadratic in {V}_{max , feas} \{ \begin{matrix}{V}_{Max , feas} = {V}_{1} + {a}_{Max}^{+} {t}_{1} \\ {S}_{1} = {V}_{1} {t}_{1} + \frac{1}{2} {a}_{Max}^{+} {t}_{1}^{2} \\ {S}_{Total} - {S}_{1} = {V}_{Max , feas} {t}_{2} - \frac{1}{2} {a}_{Max}^{-} {t}_{2}^{2} \\ {t}_{2} = \frac{{V}_{Max , feas} - {V}_{2}}{{a}_{Max}^{-}}\end{matrix} \qquad ( 19 )$$

### CONCLUSION

The systems and methods described above present a number of distinct advantages over conventional approaches. For example, the systems and methods described above advantageously enable the navigation system 130 to perform precomputations well before the mobile vehicle 110 is in transit regarding certain conditions, such as obstacle-free regions within the obstacle field 170 and the safety envelope of the mobile vehicle 110. By performing such precomputations in advance, the navigation system 130 can advantageously generate obstacle-free trajectories in substantially real time, rather than over a period of several seconds or minutes, in response to dynamic user requests made while the mobile vehicle 110 is in transit.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A mobile vehicle navigation system, comprising:
a polygon rasterization module configured to perform a polygon rasterization process on one or more maps of an obstacle field to identify obstacle-free regions within the obstacle field;
a shortest path module configured to select an optimal trajectory along which the mobile vehicle can safely traverse the obstacle field; and
a control module configured to ensure that the mobile vehicle can successfully traverse the optimal trajectory selected by the shortest path module.

2. The mobile vehicle navigation system of claim 1, wherein the mobile vehicle comprises a hover-capable UAV, a fixed-wing UAV, a mobile ground vehicle, or a UUV.

3. The mobile vehicle navigation system of claim 1, wherein obstacles within the obstacle field are included on one or more maps made available to the navigation system before the mobile vehicle is in transit.

4. The mobile vehicle navigation system of claim 1, wherein obstacles within the obstacle field are detected by one or more sensors of the mobile vehicle while the mobile vehicle is in transit.

5. The mobile vehicle navigation system of claim 1, wherein the mobile vehicle is used by military or law enforcement personnel in urban aerial combat or surveillance operations.

6. The mobile vehicle navigation system of claim 1, wherein the obstacle field is represented using a trapezoidal map.

7. The mobile vehicle navigation system of claim 1, wherein the obstacle field is represented using a Voronoi diagram.

8. The mobile vehicle navigation system of claim 1, wherein the shortest path module is configured to perform Dijkstra's algorithm for shortest path on a graph.

9. The mobile vehicle navigation system of claim 1, wherein the control module is configured to solve a one-dimensional control problem.

10. The mobile vehicle navigation system of claim 9, wherein the objective of the one-dimensional control problem is to determine the maximum possible velocity of the mobile vehicle along a graph edge of the vehicle's trajectory.

11. A method of generating an obstacle-free trajectory for a mobile vehicle through an obstacle field, the method comprising:
performing a polygon rasterization process to identify obstacle-free regions within the obstacle field;
determining a number of obstacle-free trajectories through the obstacle field;
selecting an optimal obstacle-free trajectory through the obstacle field; and
solving a control problem to ensure that the mobile vehicle can successfully traverse the selected trajectory.

12. The method of claim 11, wherein the mobile vehicle comprises a hover-capable UAV, a fixed-wing UAV, a mobile ground vehicle, or a UUV.

13. The method of claim 11, wherein obstacles within the obstacle field are included on one or more maps made available to the navigation system before the mobile vehicle is in transit.

14. The method of claim 11, wherein obstacles within the obstacle field are detected by one or more sensors of the mobile vehicle while the mobile vehicle is in transit.

15. The method of claim 11, wherein the mobile vehicle is used by military or law enforcement personnel in urban aerial combat or surveillance operations.

16. The method of claim 11, wherein the obstacle field is represented using a trapezoidal map.

17. The method of claim 11, wherein the obstacle field is represented using a Voronoi diagram.

18. The method of claim 11, wherein selecting an optimal obstacle-free trajectory comprises using Dijkstra's algorithm for shortest path on a graph.

19. The method of claim 11, wherein the control problem comprises a one-dimensional control problem.

20. The method of claim 19, wherein the objective of the one-dimensional control problem is to determine the maximum possible velocity of the mobile vehicle along a graph edge of the vehicle's trajectory.

21. The method of claim 19, wherein determining a number of obstacle-free trajectories through the obstacle field comprises filtering graph edges generated by the polygon rasterization process using the navigation envelope of the mobile vehicle.

22. A method of generating an obstacle-free trajectory for a mobile vehicle through an obstacle field, the method comprising:
performing precomputations regarding obstacle-free regions within the obstacle field and regarding the safety envelope of the mobile vehicle before the mobile vehicle is in transit;
receiving a user request to change the destination of the mobile vehicle while the mobile vehicle is in transit; and
generating an obstacle-free trajectory along which the mobile vehicle can safely reach the changed destination in substantially real time in response to the user request.

23. The method of claim 22, wherein the mobile vehicle comprises a hover-capable UAV, a fixed-wing UAV, a mobile ground vehicle, or a UUV.

24. The method of claim 22, wherein obstacles within the obstacle field are included on one or more maps made available to the navigation system before the mobile vehicle is in transit.

25. The method of claim 22, wherein obstacles within the obstacle field are detected by one or more sensors of the mobile vehicle while the mobile vehicle is in transit.

26. The method of claim 22, wherein the mobile vehicle is used by military or law enforcement personnel in urban aerial combat or surveillance operations.

27. The method of claim 22, wherein the obstacle field is represented using a trapezoidal map.

28. The method of claim 22, wherein the obstacle field is represented using a Voronoi diagram.

29. The method of claim 22, wherein generating an obstacle-free trajectory comprises performing Dijkstra's algorithm for shortest path on a graph.

30. The method of claim 22, wherein generating an obstacle-free trajectory comprises solving a one-dimensional control problem.

31. The method of claim 30, wherein the objective of the one-dimensional control problem is to determine the maximum possible velocity of the mobile vehicle along a graph edge of the vehicle's trajectory.

32. The method of claim 22, wherein the obstacle-free trajectory is generated in less than about one second after the user request is received.
